(19) United States
(12) Patent Application Publication
(10) Pub. No.: US 2025/0248871 A1
(43) Pub. Date: Aug. 7, 2025

(54) FULL-MOTION INTERRUPT SYSTEM

(71) Applicant: Sizewise Rentals, L.L.C., Eden Prairie, MN (US)

(72) Inventors: Alexandria MILLER, Muskego, WI (US); Benjamin Eric FREY, Menomonee Falls, WI (US); Michael Andrew VERHAGEN, Hartland, WI (US); Timothy James CAMPBELL, Milwaukee, WI (US); David Delroy DRISCOLL, JR., Milwaukee, WI (US)

(73) Assignee: Sizewise Rentals, L.L.C., Eden Prairie, MN (US)

(21) Appl. No.: 19/044,499

(22) Filed: Feb. 3, 2025

Related U.S. Application Data
(60) Provisional application No. 63/549,066, filed on Feb. 2, 2024.
(60) Provisional application No. 63/742,425, filed on Jan. 7, 2025.

(51) Int. Cl. A61G 7/018; A61G 7/015; G08B 7/06

(52) U.S. Cl. CPC A61G 7/018; A61G 7/015; G08B 7/06; A61G 2203/32

(57) ABSTRACT

An interrupt system may include a medical bed having an upper frame and a lower frame, the upper frame movable relative to the lower frame. An interrupt system may include a sensor configured to detect a predetermined force between the upper frame and the lower frame, wherein the sensor is configured to stop movement of the upper frame relative to the lower frame when the predetermined force is detected by the sensor. In some embodiments, movement of the upper frame is reversed after stopping movement the upper frame. The sensor may include a membrane strip connected to the medical bed. A compressible layer may be positioned between the membrane strip and the cover. The sensor may include a hall effect sensor configured to monitor a rotation of one of a shaft and a gear of an actuator connected between the upper frame and lower frame.

### CROSS-REFERENCE TO RELATED APPLICATIONS

This U.S. non-provisional patent application claims priority to U.S. Provisional Patent Application 63/549,066 filed Feb. 2, 2024, and U.S. Provisional Patent Application 63/742,425 filed Jan. 7, 2025. The contents of the identified earlier-filed applications are hereby incorporated by reference into the present application.

### FIELD OF THE DISCLOSED SUBJECT MATTER

The disclosed subject matter generally relates to a system for interrupting movement of an adjustable height bed, and more particularly, but not necessarily exclusively, to a system for interrupting movement of a medical bed.

### SUMMARY

In some aspects, the disclosed subject matter described herein relates to an interrupt system including: a medical bed having an upper frame and a lower frame, the upper frame movable relative to the lower frame; and a sensor configured to detect a predetermined force between the upper frame and the lower frame, wherein the sensor is configured to stop movement of the upper frame relative to the lower frame when the predetermined force is detected by the sensor.

In some aspects, the disclosed subject matter described herein relates to an interrupt system, wherein the upper frame is configured to move to one of a predetermined height and a predetermined distance when the sensor detects the predetermined force.

In some aspects, the disclosed subject matter described herein relates to an interrupt system, wherein the sensor includes a membrane strip connected to the medical bed.

In some aspects, the disclosed subject matter described herein relates to an interrupt system, wherein the membrane strip is connected to a top surface of the lower frame.

In some aspects, the disclosed subject matter described herein relates to an interrupt system, wherein a cover is disposed adjacent to the membrane strip, wherein the cover is detachably connected to the medical bed.

In some aspects, the disclosed subject matter described herein relates to an interrupt system, wherein a compressible layer is positioned between the sensor and the cover.

In some aspects, the disclosed subject matter described herein relates to an interrupt system, wherein the compressible layer is constructed of an ethylene propylene diene monomer.

In some aspects, the disclosed subject matter described herein relates to an interrupt system, wherein the membrane strip is connected to a foot brace extending between a pair of upper side members.

In some aspects, the disclosed subject matter described herein relates to an interrupt system, wherein the membrane strip is connected to a lift arm, wherein the lift arm is connected between the upper frame and the lower frame.

In some aspects, the disclosed subject matter described herein relates to an interrupt system, wherein the interrupt system generates an interrupt alarm if the sensor detects the predetermined force.

In some aspects, the disclosed subject matter described herein relates to an interrupt system, wherein the interrupt alarm includes an audible alarm.

In some aspects, the disclosed subject matter described herein relates to an interrupt system, wherein the interrupt alarm includes a visual alarm.

In some aspects, the disclosed subject matter described herein relates to an interrupt system, further including: an actuator having an actuator motor, the actuator connected between the upper frame and the lower frame, wherein the actuator configured to move the upper frame relative to the lower frame; wherein the sensor includes a hall effect sensor configured to monitor a rotation of one of a shaft and a gear of the actuator; and whereby the actuator motor is reversed if the hall effect sensor does not detect the rotation of one of the shaft and the gear while the actuator motor is running.

In some aspects, the disclosed subject matter described herein relates to an interrupt system, wherein the actuator motor is configured to move the upper frame a one of a predetermined distance, a predetermined height, and predetermined amount of degrees.

In some aspects, the disclosed subject matter described herein relates to an interrupt system, wherein the interrupt system generates an interrupt alarm if the hall effect sensor does not detect the rotation of one of the shaft and the gear while the actuator motor is running.

In some aspects, the disclosed subject matter described herein relates to an interrupt system, wherein the interrupt alarm includes an audible alarm.

In some aspects, the disclosed subject matter described herein relates to an interrupt system, wherein the interrupt alarm includes a visual alarm.

In some aspects, the disclosed subject matter described herein relates to an interrupt system including: a medical bed having an upper frame and a lower frame, the upper frame movable relative to the lower frame; and a membrane strip connected to the medical bed, the membrane strip configured to detect a predetermined force between the upper frame and the lower frame, wherein the membrane strip is configured to stop movement of the upper frame relative to the lower frame when the predetermined force is detected by the membrane strip.

In some aspects, the disclosed subject matter described herein relates to an interrupt system, wherein a cover is disposed adjacent to the membrane strip, wherein the cover is detachably connected to the medical bed.

In some aspects, the disclosed subject matter described herein relates to an interrupt system, wherein a compressible layer is positioned between the membrane strip and the cover.

### BRIEF DESCRIPTION OF THE DRAWINGS

The detailed description particularly refers to the accompanying figures, in which:

FIG. 1 is a top perspective view of a medical bed in accordance with an embodiment of the disclosed subject matter.

FIG. 2 is a bottom perspective view of a medical bed in accordance with an embodiment of the disclosed subject matter.

FIG. 3 is a cross-section view of a membrane strip in accordance with an embodiment of the disclosed subject matter.

FIG. 4 is a is perspective view of a cover in accordance with an embodiment of the disclosed subject matter.

FIG. 5 is a cross-section view of a cover, compressible layer, membrane strip, and structural member in accordance with an embodiment of the disclosed subject matter.

FIG. 6 is a cross-section view of a cover in accordance with an embodiment of the disclosed subject matter.

FIG. 7 is a schematic view of a system in accordance with an embodiment of the disclosed subject matter.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Although the disclosed subject matter has been disclosed with reference to various embodiments, it is understood that equivalents may be employed, and substitutions made herein without departing from the scope of the disclosed subject matter as recited in the claims.

Certain terminology will be used in the following description, and are shown in the drawings, and will not be limiting. For example, up, down, front, back, right, and left refer to the disclosed subject matter as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

The disclosed subject matter will now be described with reference to the drawing figures, in which like reference numerals refer to like parts throughout. For purposes of clarity in illustrating the characteristics of the present disclosed subject matter, proportional relationships of the elements have not been maintained in the figures. In some cases, the sizes of certain small components have been exaggerated for illustration.

Although the subject matter has been disclosed with reference to various particular embodiments, it is understood that equivalents may be employed and substitutions made herein without departing from the scope of the subject matter.

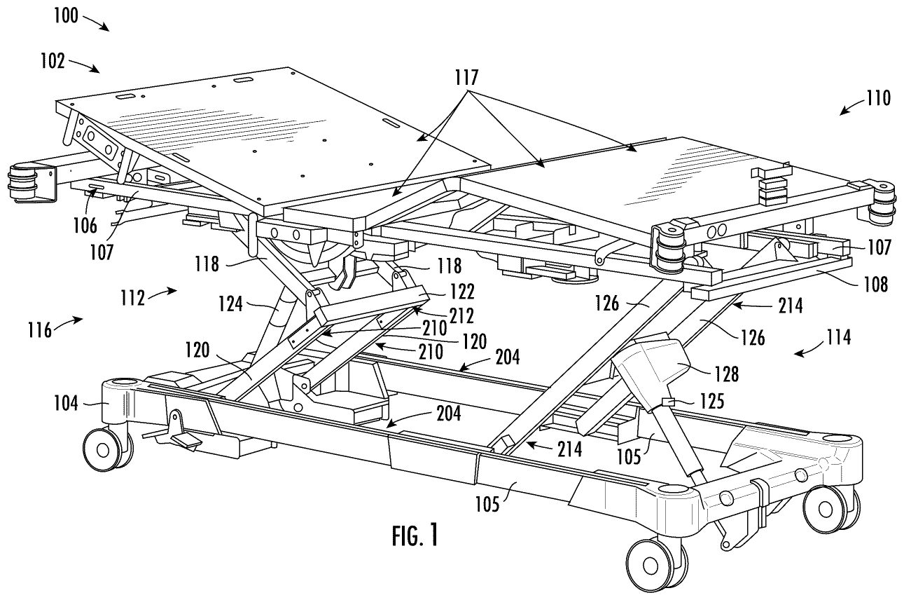

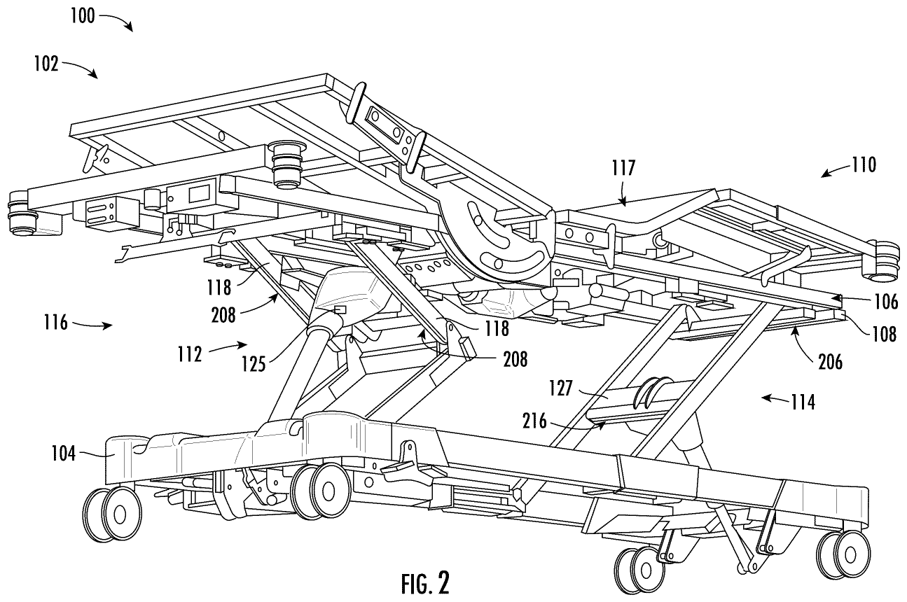

Referring to the drawings, FIGS. 1-2 show an embodiment of a medical bed 100 comprising a patient support assembly 102 having a lower frame 104 and an upper frame 106 movable relative to the lower frame 104. The lower frame 104 may comprise a pair of lower side members 105 in parallel arrangement with each other. The upper frame 106 may comprise a pair of upper side members 107 and a foot brace 108 connected between the pair of upper side members 107; wherein the foot brace 108 is connected between the pair of upper side members 107 generally at a foot end 110 of the upper frame 106.

In an embodiment of the disclosed subject matter, the upper frame 106 may be supported on a pair of lift arms 112 and 114, respectively. The lift arms 112 are positioned generally at a head end 116 of the lower frame 104, while the lift arms 114 are positioned generally at the foot end 110 of the lower frame 104. The medical bed 100 may comprise of a plurality of patient support surfaces 117 connected to the upper frame 106. In some embodiments, the plurality of patient support surfaces 117 may articulate relative to the upper frame 106. Reference to the head end 116 and the foot end 110 of the medical bed 100 is intended to provide an orientation reference and does not refer to any specific surface or element of the medical bed 100.

In an embodiment of the disclosed subject matter, the lift arms 112 and 114 are configured to independently move the upper frame 106 relative the lower frame 104. The upper frame 106 may be moved vertically relative to the lower frame 104. The upper frame 106 may be rotated or tilted relative to the lower frame 104 through movement of one or more of the lift arms 112 and 114.

In an embodiment of the disclosed subject matter, the lift arms 112 may comprise: a pair of upper head arms 118 rotatably connected to the upper frame 106, the pair of upper head arms 118 may extend downwardly from the upper frame 106 and towards foot end 110; a pair of lower head arms 120 rotatably connected to the lower frame 104, the pair of lower head arms 120 may extend upwardly from the lower frame 104 and towards the foot end 110; wherein the pair of upper head arms 118 are rotatably connected to the pair of lower head arms 120. In an embodiment of the disclosed subject matter, a first cross brace 122 may be connected between the pair of lower head arms 120 to provide structural rigidity to the lift arms 112. A first actuator 124 may be rotatably connected between the lower frame 104 and the pair of upper head arms 118; wherein the first actuator 124 is configured to raise and lower the upper frame 106 relative to the lower frame 104 through rotation of the pair of upper head arms 118 and the lower head arms 120. In an embodiment of the disclosed subject matter, the first actuator 124 may comprise a linear actuator.

In an embodiment of the disclosed subject matter, the lift arms 114 may comprise a pair of foot arms 126 rotatably connected between the lower frame 104 and the upper frame 106. The pair of foot arms 126 may extend downwardly from the upper frame 106 and towards the head end 116. In an embodiment of the disclosed subject matter, a second cross brace 127 may be connected between the pair of foot arms 126 to provide structural rigidity to the lift arms 114. In an embodiment, a second actuator 128 may be rotatably connected between the lower frame 104 and the pair of foot arms 126; wherein the second actuator 128 is configured to raise and lower the upper frame 106 relative to the lower frame 104 through rotation of the pair of foot arms 126. In an embodiment, one or more hall effect sensors 125 may be used to monitor the rotation of shafts or gears (not shown) of the first actuator 124 and the second actuator 128 and hence the positions of the first actuator 124 and the second actuator 128 to control the movement of the upper frame 106 relative to the lower frame 104 as described above.

In an embodiment of the disclosed subject matter, the patient support assembly 102 may include a sensor 200 to detect when an obstruction, such as a human appendage or physical object, may be resisting the downward movement of the upper frame 106 in order to prevent damage and/or injury to the obstruction and or the patient support assembly 102. The sensor 200 may interrupt the downward movement of the upper frame 106 in order for a user to assess and relocate the obstruction. The sensor 200 may be configured to stop the downward movement of the upper frame 106 when a predetermined force F is sensed by the sensor 200. The sensor may be further configured to generate an interrupt alarm when a predetermined force F is sensed by the sensor 200. The interrupt alarm may be one of an audible alarm and a visual alarm.

The sensor 200 may be connected to the patient support assembly 102 to the sense whether the obstruction is impinging upon the downward movement of the patient support assembly 102. In an embodiment the sensor 200 may be connected to one or more of a top surface 204 of the lower side members 105, a first bottom surface 206 of the foot brace 108, a second bottom surface 208 of the upper head arms 118, a third bottom surface 210 of the lower head arms 120, a fourth bottom surface 212 of the first cross brace 122, a fifth bottom surface 214 of the foot arms 126, and a sixth bottom surface 216 of the second cross brace 127. The sensor 200 may be connected to other structural elements of the patient support assembly 102 to detect the presence of an obstruction depending on the application.

The sensor 200 may comprise a membrane strip 220 configured to detect a predetermined force F applied to a top sensor surface 222. In an embodiment, the top sensor surface 222 may detect a predetermined force F of at least about 1 lbf (4.448 N).

In an embodiment the membrane strip 220 may be connected to the top surface 204, the first bottom surface 206, the second bottom surface 208, the third bottom surface 210, the fourth bottom surface 212, the fifth bottom surface 214, and the sixth bottom surface 216 by means of adhesives or other means of physical connection.

In another embodiment, the one or more hall effect sensors 125 are used to monitor the actuators (124,128) and the one or more actuator motors (not shown) may be equipped with a clutch (not shown) to protect the one or more actuator motors, with the clutches operating as an auto-ratchet feature to disengage at a predetermined torque indicative of an obstruction. In each actuator (124,128), the clutch disengages the shaft (not shown) from the one or more actuator motors to cease movement of the upper frame 106. The one or more hall effect sensors 125 monitors rotation of a shaft, gear, or other component of the actuators (124,128), and if the one or more hall effect sensors 125 detect no rotation while the one or more actuator motors is still operating (as detected by a current/Amperage sensor on the one more actuator motors), then the system will stop the one or more actuator motors. In another embodiment, the system will reverse the one or more actuator motors and engage the clutch to retreat the surface away from the potential obstruction. The upper frame 106 may be retreated to a safe level and inclination, such as level at a predetermined height. Alternatively, the upper frame 106 will be retreated by a predetermined amount of degrees of 1, 2, 5, or 10 degrees or an amount of degrees approximately within that range, and in the further alternative, the upper frame 106 will be retreated by a predetermined distance of 1, 2, 5, or 10 mm or a distance approximately within that range.

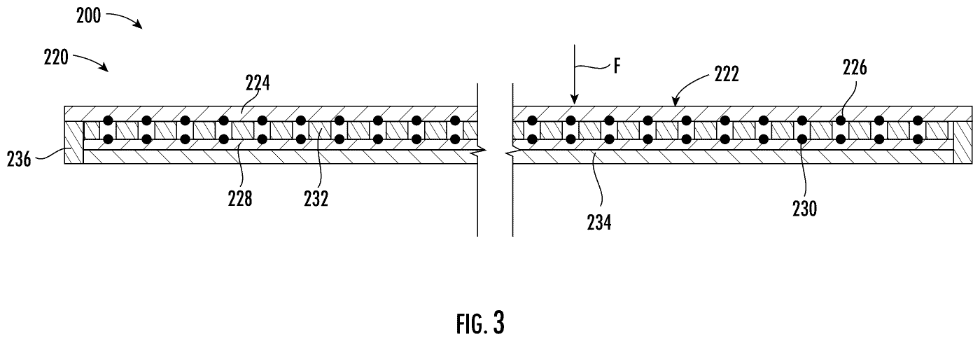

Referring to FIG. 3, the membrane strip 220 may be configured to detect a predetermined force F on a top sensor surface 222 of the membrane strip 220. The membrane strip 220 may comprise a top circuit layer 224 having a top sensor surface 222 and a first printed circuit 226 extending along at least a portion of the length of the top circuit layer 224, a bottom circuit layer 228 having a second printed circuit 230, a spacer 232 connected between the top circuit layer 224 and the bottom circuit layer 228, an adhesive layer 234 positioned below the bottom circuit layer 228, and a gasket 236 enclosing the peripheries of the spacer 232, the bottom circuit layer 228, and the spacer 232. The top circuit layer 224 may be connected to the spacer 232 and the gasket 236. In operation, a continuous open circuit is run through the second printed circuit 230 of the bottom circuit layer 228. When a predetermined force F is applied to the top sensor surface 222, the first printed circuit 226 of the top circuit layer 224 is urged through the spacer 232 and contacts the second printed circuit 230 which momentarily shorts the second printed circuit 230.

In an embodiment, the membrane strip 220 is about 0.02 inches (0.508 mm) thick and 0.75 inches (19.05 mm) wide. The length of the membrane strip 220 will depend on the location of the application.

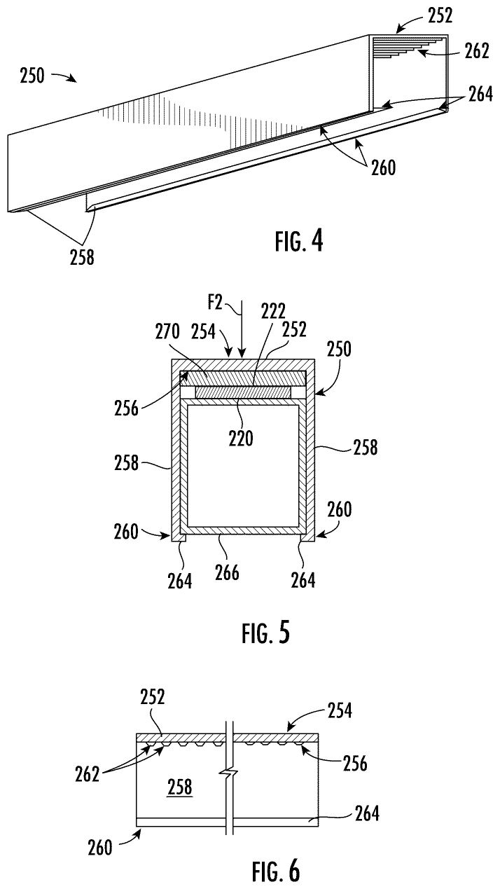

Referring to FIGS. 4-6, in an embodiment of the disclosed subject matter, a cover 250 may be disposed adjacent to, or abut, the sensor 200, such as a membrane strip 220. In an embodiment, the cover 250 may be detachably connected to the medical bed 100. The cover 250 may include a top member 252 having an exterior surface 254 and an interior surface 256 opposite the exterior surface 254. The cover 250 may further include a pair of side walls 258 extending downwardly from the top member 252, the pair of side walls 258 being in parallel arrangement and terminating along a pair of distal edges 260. The cover 250 may include a plurality of extensions 262 extending outwardly from the interior surface 256 and extending between the pair of side walls 258. The pair of side walls 258 may include a pair of tabs 264 extending towards each other from the pair of the distal edges 260 in order to secure the cover 250 to a structural member 266. The structural member 266 may comprise, by way of example, the lower side members 105, the foot brace 108, the upper head arms 118, the lower head arms 120, the first cross brace 122, the foot arms 126, and the second cross brace 127. The structural member 266 may comprise other members of the patient support assembly 102.

In an embodiment, a compressible layer 270 may be located between the cover 250 and the sensor 200 to prevent direct contact between the interior surface 256 and the top sensor surface 222. The compressible layer 270 protects the top sensor surface 222 from potential deformation of the membrane strip 220 if the interior surface 256 of the cover 250 is allowed to contact the top sensor surface 222. The compressible layer 270 may be configured to extend over at least a portion the membrane strip 220 so as to prevent contact of the interior surface 256 with the top sensor surface 222. In some embodiments, the compressible layer 270 is constructed of rubber, foam, or other suitable compressible material. In some embodiments, the compressible layer 270 is constructed of ethylene propylene diene monomer (EPDM). In an embodiment, the compressible layer 270 may have a thickness of between about 0.016 inches and about 0.250 inches. In other embodiments, the compressible layer 270 may have a thickness of between about 0.031 inches and about 0.188 inches. In still other embodiments, the compressible layer 270 may have a thickness of about 0.063 inches.

The rigidity of the cover 250 assists in concentrating a force F applied to the exterior surface 254 of the cover 250 in order to reduce the force F required to trigger the sensor 200 and/or momentarily short the second printed circuit 230. In an embodiment, the membrane strip 220 is located between compressible layer 270 and the structural member 266. In an embodiment, the cover 250 may be secured to the structural member 266 by means of adhesives, rivets, welds, snaps, hook and loop connectors, physical connections, or other means of attachments known in the art. In an embodiment, the cover 250 may be securely fit to the structural member 266 by means of the pair of tabs 264.

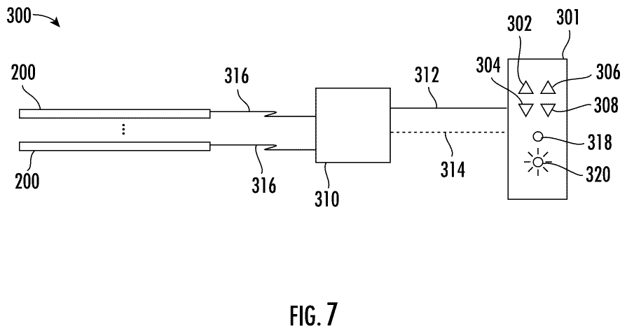

Referring to FIG. 7, in an embodiment of the disclosed subject matter, a system 300 for interrupting the movement of the medical bed 100 may include a user remote 301 configured to control the upward and downward movement of the first actuator 124 and the second actuator 128. The user remote 301 may comprise a first button 302 configured to control the elongation of the first actuator 124; wherein the first actuator 124 is elongated when the first button 302 is pressed, thereby raising the head end 116 of the upper frame 106. The user remote 301 may comprise a second button 304 configured to control the contraction of the first actuator 124; wherein the first actuator 124 is contracted when the second button 304 is pressed, thereby lowering the head end 116 of the upper frame 106. In a similar manner, the user remote 301 may comprise a third button 306 configured to control the elongation of the second actuator 128; wherein the second actuator 128 is elongated when the third button 306 is pressed, thereby raising the foot end 110 of the upper frame 106. The user remote 301 may additionally comprise a fourth button 308 configured to control the contraction of the second actuator 128; wherein the second actuator 128 is contracted when the fourth button 308 is pressed, thereby lowering the foot end 110 of the upper frame 106.

In an embodiment of the disclosed subject matter, the system 300 for interrupting the movement of the medical bed 100 may comprise a controller 310 configured to detect the momentary short of the second printed circuit 230 when a predetermined force F is applied to the top member 252. Upon detection of the momentary short, the controller 310 is configured to stop the downward movement of the upper frame 106 by stopping movement of one or both of the first actuator 124 and the second actuator 128. In addition, upon detection of the momentary short, the controller 310 may be configured to temporarily reverse the direction of the one or both of the first actuator 124 and the second actuator 128. Furthermore, upon detection of the momentary short, the controller 310 may be configured generate an interrupt alarm which may comprise one of an audible alarm and a visual alarm. The audible alarm may comprise generation of a sound from a speaker 318 on the user remote 301 or other suitable location. The visible alarm may comprise powering a light 320 on the user remote 301 or other suitable location.

The controller 310 may be physically connected to the user remote 301 via a wire 312 or wirelessly connected to the user remote 301 via a wireless signal 314. The controller 310 may be electronically connected to the sensor 200 by means of a wired connection 316.

In an embodiment, the controller is configured to resume downward movement of the first actuator 124 and the second actuator 128 only after a user stops pressing one or both of the second button 304 and the fourth button 308. The user should check for, and remove, any obstructions that would trigger the sensor 200. After any obstructions have been removed, the user may continue to move the upper frame 106 downwardly as discussed above.

In an embodiment, a method for interrupting the downward movement of an upper frame of a medical bed may comprise the steps of: (1) providing a senor connected to a structural element of the medical bed, the sensor configured to detect a predetermined force; (2) moving the upper frame downwardly; (3) detecting the predetermined force with the sensor; (4) stopping the downward movement of the upper frame; and (5) extending at least one of the first actuator and the second actuator a predetermined distance. In an embodiment, the predetermined distance may be between about 1 mm to about 20 mm. In an embodiment, the predetermined distance may be between about 5 mm to about 15 mm. In another embodiment, the predetermined distance may be about 10 mm. In an embodiment, the method may further comprise the steps of: (6) relocating an obstruction; and (7) resuming downward movement of the upper frame. The method may further comprise the step of providing a compressible layer over the sensor, and even further comprise providing a cover over the compressible layer; whereby a force on a top member of the cover is distributed through the compressible layer to the sensor. In an embodiment the sensor may comprise a membrane strip connected to the structural element. In an embodiment, the method may further comprise the step of generating an interrupt alarm. The interrupt alarm may comprise one of an audible alarm and a visual alarm.

It is to be understood that while certain aspects of the disclosed subject matter have been shown and described, the disclosed subject matter is not limited hereto and encompasses various other embodiments as aspects.

Having described the disclosed subject matter, what is claimed as new and desired to be secured by Letters Patent is:

1. An interrupt system comprising:
a medical bed having an upper frame and a lower frame, the upper frame movable relative to the lower frame; and
a sensor configured to detect a predetermined force between the upper frame and the lower frame,
wherein the sensor is configured to stop movement of the upper frame relative to the lower frame when the predetermined force is detected by the sensor.

2. The interrupt system of claim 1, wherein the upper frame is configured to move to one of a predetermined height and a predetermined distance when the sensor detects the predetermined force.

3. The interrupt system of claim 1, wherein the sensor comprises a membrane strip connected to the medical bed.

4. The interrupt system of claim 3, wherein the membrane strip is connected to a top surface of the lower frame.

5. The interrupt system of claim 3, wherein a cover is disposed adjacent to the membrane strip, wherein the cover is detachably connected to the medical bed.

6. The interrupt system of claim 5, wherein a compressible layer is positioned between the sensor and the cover.

7. The interrupt system of claim 6, wherein the compressible layer is constructed of an ethylene propylene diene monomer.

8. The interrupt system of claim 3, wherein the membrane strip is connected to a foot brace extending between a pair of upper side members.

9. The interrupt system of claim 3, wherein the membrane strip is connected to a lift arm, wherein the lift arm is connected between the upper frame and the lower frame.

10. The interrupt system of claim 1, wherein the interrupt system generates an interrupt alarm if the sensor detects the predetermined force.

11. The interrupt system of claim 10, wherein the interrupt alarm comprises an audible alarm.

12. The interrupt system of claim 10, wherein the interrupt alarm comprises a visual alarm.

13. The interrupt system of claim 1, further comprising:
an actuator having an actuator motor, the actuator connected between the upper frame and the lower frame, wherein the actuator configured to move the upper frame relative to the lower frame;
wherein the sensor comprises a hall effect sensor configured to monitor a rotation of one of a shaft and a gear of the actuator; and
whereby the actuator motor is reversed if the hall effect sensor does not detect the rotation of one of the shaft and the gear while the actuator motor is running.

14. The interrupt system of claim 13, wherein the actuator motor is configured to move the upper frame a one of a predetermined distance, a predetermined height, and predetermined amount of degrees.

15. The interrupt system of claim 13, wherein the interrupt system generates an interrupt alarm if the hall effect sensor does not detect the rotation of one of the shaft and the gear while the actuator motor is running.

16. The interrupt system of claim 15, wherein the interrupt alarm comprises an audible alarm.

17. The interrupt system of claim 15, wherein the interrupt alarm comprises a visual alarm.

18. An interrupt system comprising:
a medical bed having an upper frame and a lower frame, the upper frame movable relative to the lower frame; and
a membrane strip connected to the medical bed, the membrane strip configured to detect a predetermined force between the upper frame and the lower frame,
wherein the membrane strip is configured to stop movement of the upper frame relative to the lower frame when the predetermined force is detected by the membrane strip.

19. The interrupt system of claim 18, wherein a cover is disposed adjacent to the membrane strip, wherein the cover is detachably connected to the medical bed.

20. The interrupt system of claim 19, wherein a compressible layer is positioned between the membrane strip and the cover.
